(19) United States
(12) Patent Application Publication
(10) Pub. No.: US 2026/0102819 A1
(43) Pub. Date: Apr. 16, 2026

(54) IRON-BASED SOFT MAGNETIC COMPOSITE POWDER FOR A DUST CORE, AND METHOD OF PRODUCING SAME

(71) Applicant: JFE STEEL CORPORATION, Chiyoda-ku, Tokyo (JP)

(72) Inventors: Takechika NAKAMURA, Chiyoda-ku, Tokyo (JP); Takuya TAKASHITA, Chiyoda-ku, Tokyo (JP); Hiroyuki MASUOKA, Chiyoda-ku, Tokyo (JP); Akira MATSUZAKI, Chiyoda-ku, Tokyo (JP)

(73) Assignee: JFE STEEL CORPORATION, Chiyoda-ku, Tokyo (JP)

(21) Appl. No.: 19/117,635

(22) PCT Filed: Jul. 27, 2023
(86) PCT No.: PCT/JP2023/027667

§ 371 Date: Apr. 2, 2025

(30) Foreign Application Priority Data
Oct. 31, 2022 (JP) 2022-175117

(51) Int. Cl. B22F 1/16; B22F 1/102; B22F 9/08; H01F 1/26; H01F 3/08; H01F 41/02

(52) U.S. Cl. CPC B22F 1/16; B22F 1/102; H01F 1/26; H01F 3/08; H01F 41/0246; B22F 9/082; B22F 2009/0828; B22F 2301/35

(57) ABSTRACT

Provided is an iron-based soft magnetic composite powder for a dust core that has an insulating layer and also high flowability, and a method of easily producing same. The iron-based soft magnetic composite powder for a dust core includes coated particles having an insulating layer formed on the particle surface of iron-based soft magnetic particles. The insulating layer includes a first coating layer formed of aluminum tripolyphosphate disposed on the particle surface and a second coating layer formed of silicone resin disposed on the first coating layer. Coverage of the insulating layer on the particle surface is 85% or more.

### TECHNICAL FIELD

The present disclosure relates to an iron-based soft magnetic composite powder for a dust core and a method of producing same.

### BACKGROUND

Magnetic cores applied to power conversion devices such as motors and transformers have been made using stacked electrical steel sheets, but in recent years there has been an increase in the use of dust cores. Dust cores are made by filling a press mold with iron-based soft magnetic powder and compression molding. This allows for a high degree of freedom in component shape and the realization of motors having complex shapes. Further, dust cores can be formed by compression molding, and therefore a formed body can be obtained close to the final component shape, which improves yield.

Each of the iron-based soft magnetic particles is insulated in a dust core, and therefore eddy currents can be suppressed compared to stacked electrical steel sheets, enabling higher efficiency in power conversion devices. To produce a dust core, a powder of coated particles each having an insulating coating formed on the surface (iron-based soft magnetic composite powder) is required.

In order to obtain the desired performance as a magnetic core, increasing the density of the dust core is necessary. To increase the density of the dust core, it is desirable for the coated particles having insulating coating in the iron-based soft magnetic composite powder to have a high coverage of insulating coating while using a small amount of coating material for insulation.

Further, in order to obtain appropriate formability, the frictional resistance between the formed body and the press mold is preferably small when the dust core is extracted from the press mold after compression molding. Therefore, a lubricant may be added to the iron-based soft magnetic composite powder to reduce frictional resistance between the formed body and the press mold. However, the flowability of iron-based soft magnetic composite powder with added lubricant may degrade. Poor flowability of the iron-based soft magnetic composite powder may cause clogging in a storage container of the iron-based soft magnetic composite powder, or inhibit uniform filling when filling the press mold with the iron-based soft magnetic composite powder. Therefore, it is desirable to secure the flowability of iron-based soft magnetic composite powder with lubricant added.

JP 2008-063651 A (Patent Literature (PTL) 1) describes an iron-based soft magnetic powder for a dust core, a method of producing same, and a dust core. In the described iron-based soft magnetic powder for a dust core, a phosphoric acid-based chemical conversion layer and a silicone resin coating are formed on the surface in this order. In the described method of producing an iron-based soft magnetic powder for a dust core, a phosphoric acid solution and an iron-based soft magnetic powder are mixed, and then the solvent is evaporated to form a phosphoric acid-based chemical conversion layer on the surface of the iron-based soft magnetic powder. Further, in the described method of producing an iron-based soft magnetic powder for a dust core, silicone resin is dissolved in an organic solvent, the silicone resin solution is mixed with the iron-based soft magnetic powder, and then the solvent is evaporated to form a silicone resin coating on the phosphoric acid-based chemical conversion layer.

WO 2021/199525 A1 (PTL 2) describes an iron-based soft magnetic powder for a dust core, a dust core, and methods of producing same. In the described iron-based soft magnetic powder for a dust core, the surface of the iron-based soft magnetic powder has a condensed aluminum phosphate layer, and further, the surface of the condensed aluminum phosphate layer has a silicone resin layer. The condensed aluminum phosphate layer is considered to be a continuous coating. The term “continuous coating” in this iron-based soft magnetic powder for a dust core is said to mean that powder particles may be fully or partially coated, and powder particles are fused together so coated sites are continuous, and is distinguished from a state in which powder particles are adhered to each other sporadically. In the described iron-based soft magnetic powder for a dust core, the majority of the surface of the iron-based soft magnetic powder is preferably covered by continuous coating, and more preferably substantially all of the surface is covered by continuous coating. In the described method of producing an iron-based soft magnetic powder for a dust core, iron-based soft magnetic powder and condensed aluminum phosphate powder are heat-mixed to obtain an iron-based soft magnetic powder having a condensed aluminum phosphate layer on the surface, and then silicone resin is adhered to the condensed aluminum phosphate layer to form a silicone resin layer on the surface of the condensed aluminum phosphate layer.

JP 2007-535134 A (PTL 3) describes a powder composition. The powder composition consists of electrically insulated particles of soft magnetic material of iron or iron-based powder and 0.1 wt % to 2 wt % of a lubricant selected from the group consisting of fatty acid amides having 14 to 22 C atoms.

JP H09-104901 A (PTL 4) describes an iron-based powder mixture for powder metallurgy and a method of producing same. The described iron-based powder mixture for powder metallurgy contains an iron-based powder, a lubricant, and an alloying powder. At least one selected from the group consisting of the iron-based powder, the lubricant, and the alloying powder is preferably coated with a surface treatment agent, which is at least one selected from the group consisting of organoalkoxysilanes, organosilazanes, silicone oils, titanate coupling agents, fluorine coupling agents, and mineral oils. In PTL 4, it is indicated that, due to the high frictional resistance and bond strength between metal powder and organic compounds, the flowability of metal powder mixed with an organic compound such as a lubricant is extremely poor compared to metal powder not mixed with an organic compound such as a lubricant.

### CITATION LIST

### Patent Literature

PTL 1: JP 2008-063651 A
PTL 2: WO 2021/199525 A1
PTL 3: JP 2007-535134 A
PTL 4: JP H09-104901 A

### SUMMARY

### Technical Problem

In the method of producing an iron-based soft magnetic powder for a dust core as described in PTL 1, drying of the solvent of the phosphoric acid solution after mixing the phosphoric acid solution and the iron-based soft magnetic powder is necessary. Accordingly, there is a concern that an iron-based powder that has a large specific surface area is easily oxidized. Further, when evaporating the organic solvent after mixing the silicone resin solution with the iron-based soft magnetic powder, safety precautions against explosions and the like are required. In addition, the coating formation method via a solution is prone to powder agglomeration, which may decrease powder flowability.

In the method of producing an iron-based soft magnetic powder for a dust core as described in PTL 2, it may not be possible to obtain a powder having sufficiently high coverage when an iron-based soft magnetic powder and a condensed aluminum phosphate powder are heat-mixed.

In the powder composition described in PTL 3, a decrease in flowability may occur due to the addition of a lubricant when the powder composition is stored in a static state.

Against this background, it is desirable to provide an iron-based soft magnetic composite powder for a dust core that has an insulating layer and also high flowability, and a method of easily producing same.

It would be helpful to provide an iron-based soft magnetic composite powder for a dust core that has an insulating layer and also high flowability, and a method of easily producing same.

### Solution to Problem

The iron-based soft magnetic composite powder for a dust core according to the present disclosure is as follows.

[1] An iron-based soft magnetic composite powder for a dust core, the iron-based soft magnetic composite powder comprising (consisting of):
coated particles having an insulating layer formed on the particle surface of iron-based soft magnetic particles,
the insulating layer comprising:
a first coating layer formed of aluminum tripolyphosphate disposed on the particle surface; and
a second coating layer formed of silicone resin disposed on the first coating layer, wherein coverage of the insulating layer on the particle surface is 85% or more.

The iron-based soft magnetic composite powder for a dust core according to the present disclosure may further be configured as follows.

[2] The iron-based soft magnetic composite powder for a dust core according to [1], wherein the coverage is a value calculated by the following Expression,
where α is the energy spectrum area attributed to Fe as measured by low-energy ion scattering spectroscopy with respect to the iron-based soft magnetic particles, and
β is the energy spectrum area attributed to Fe as measured by low-energy ion scattering spectroscopy with respect to the coated particles,

$$( 1 - β / α ) \times 100. \qquad ( Expression 1 )$$

[3] The iron-based soft magnetic composite powder for a dust core according to [1] or [2], further comprising an organic lubricant in an amount from 0.20 mass % to 0.60 mass %.

The iron-based soft magnetic composite powder for a dust core according to any one of [1] to [3] may be produced by the following production method.

[4] A method of producing the iron-based soft magnetic composite powder for a dust core, the method comprising adding and mixing a silicone resin powder to powder consisting of coated particles with only the first coating layer formed, thereby forming the second coating layer.

[5] The method of producing an iron-based soft magnetic composite powder for a dust core according to [4], wherein the powder including the coated particles is mixed with an organic lubricant powder.

### Advantageous Effect

According to the present disclosure, it is possible to provide an iron-based soft magnetic composite powder for a dust core that has an insulating layer and also high flowability, and a method of easily producing same.

### DETAILED DESCRIPTION

The following is a description of the iron-based soft magnetic composite powder for a dust core and a method of producing same.

First, an overview of the iron-based soft magnetic composite powder for a dust core (hereinafter also simply referred to as “iron-based soft magnetic composite powder”) according to the present embodiment is described.

The iron-based soft magnetic composite powder according to the present embodiment contains coated particles that have an insulating layer formed on the particle surface of iron-based soft magnetic particles. The insulating layer comprises a first coating layer formed of aluminum tripolyphosphate disposed on the particle surface and a second coating layer formed of silicone resin disposed on the first coating layer. Here, the coverage of the insulating layer on the particle surface is 85% or more.

As an example, the iron-based soft magnetic composite powder according to the present embodiment is produced by a method of adding and mixing a silicone resin powder to a powder consisting of coated particles with only the first coating layer formed, thereby forming the second coating layer.

The iron-based soft magnetic composite powder according to the present embodiment has an insulating layer and also high flowability. Further, the iron-based soft magnetic composite powder according to the present embodiment can be easily produced, for example, by the production method described above. For example, the iron-based soft magnetic composite powder according to the present embodiment can be produced by an easy production method that does not use an organic solvent and does not include a process of drying an organic solvent in the production process.

The following is a detailed description of the iron-based soft magnetic composite powder according to the present embodiment and a method of producing same.

The iron-based soft magnetic composite powder according to the present embodiment includes coated particles. The term coated particles refers to iron-based soft magnetic particles having an insulating layer formed on the particle surface. The iron-based soft magnetic particles are particles that constitute iron-based soft magnetic powder. In other words, the iron-based soft magnetic composite powder according to the present embodiment includes coated particles that have an insulating layer formed on the surface of particles that constitute iron-based soft magnetic powder. Here, iron-based powder refers to metal powder having an Fe content of 50 mass % or more. That is, the iron-based soft magnetic composite powder and the iron-based soft magnetic powder have an Fe content of 50 mass % or more. Composite powder refers to powder including composite particles. Composite particles are particles that include at least two materials. For example, the coated particles are composite particles because an insulating layer is formed on the particle surface of the iron-based soft magnetic particles that are core particles (nuclear particles).

The iron-based soft magnetic composite powder according to the present embodiment may contain any additive (for example, lubricant) other than the coated particles, and may consist of the coated particles and organic lubricant, and may consist of only the coated particles.

Hereinafter, the iron-based soft magnetic powder may be referred to simply as iron-based powder.

The iron-based soft magnetic powder is preferably iron powder. Iron powder refers to powder consisting of Fe and inevitable impurity, and is typically referred to as pure iron powder in the technical field.

The iron-based soft magnetic powder may be produced by any method. For example, the iron-based soft magnetic powder may be reduced iron-based powder, atomized iron-based powder, or a mixture thereof. Reduced iron-based powder is iron-based powder produced by reducing iron oxide. Atomized iron-based powder is iron-based powder produced by an atomizing method. Examples of atomized iron-based powder include water-atomized iron-based powder and gas-atomized iron-based powder. Here, the iron-based soft magnetic powder is preferably a water-atomized iron-based powder. Water-atomized iron-based powder has numerous irregularities on the particle surface, which may lead to entanglement of the particles, and may improve the strength of a dust core when molded as a dust core. Further, the iron-based soft magnetic powder preferably has good compressibility. Good compressibility improves the formability of a dust core when compressed and molded.

The apparent density of the iron-based soft magnetic powder is preferably 2.8 Mg/m³ or more. When the apparent density is less than 2.8 Mg/m³, the density of a dust core may decrease.

The particle size of the iron-based soft magnetic powder, when evaluated in terms of volume-based median size (50% particle diameter, so-called D₅₀) is preferably 40 μm or more. Hereinafter, when particle size is referred to, the meaning is median size. When the particle size is less than 40 μm, the flowability of the iron-based soft magnetic powder may decrease. Further, the ability to fill the press mold with the iron-based soft magnetic composite powder may be decreased, and furthermore, formability may be worse when a dust core is compressed and molded. Therefore, from the viewpoint of further improving flowability, the particle size is preferably 40 μm or more. On the other hand, when the particle size exceeds 400 μm, the flowability of the iron-based soft magnetic powder may decrease. Further, the ability to fill the press mold with the iron-based soft magnetic composite powder may be decreased, and furthermore, formability may be worse when a dust core is compressed and molded. Therefore, from the viewpoint of further improving flowability, the particle size is preferably 400 μm or less. The particle size may be the median value measured using a particle size distribution measuring device employing a laser diffraction method. For example, Partica LA-960V2, produced by HORIBA Ltd. may be used as a particle size distribution measuring device.

The coated particles according to the present embodiment have an insulating layer formed on the particle surface of the iron-based soft magnetic particles. The insulating layer comprises the first coating layer and the second coating layer.

The first coating layer is formed of aluminum tripolyphosphate disposed on the particle surface. Here, the first coating layer is a layer that insulates.

The aluminum tripolyphosphate is a raw material for forming the first coating layer having an insulating property on the surface of the iron-based soft magnetic particles. Aluminum tripolyphosphate has good reactivity with iron, and by using aluminum tripolyphosphate powder, the first coating layer is formed having high adhesiveness and adhesion to the surface of the iron-based soft magnetic particles and also having an insulation property. An example of the aluminum tripolyphosphate is aluminum dihydrogen tripolyphosphate. Further, the aluminum tripolyphosphate may be in any hydrated state, such as a dihydrate.

For example, the aluminum tripolyphosphate is preferably used in powder form. An example of a suitable aluminum tripolyphosphate powder is K-FRESH #100P, produced by Tayca Co., Ltd. The particle size (median size) of the aluminum tripolyphosphate powder is preferably 10 μm or less. The particle size of the aluminum tripolyphosphate powder is more preferably 5 μm or less. The smaller the particle size of the aluminum tripolyphosphate powder, the greater the specific surface area of the powder, and therefore the higher the coverage. A lower limit of the particle size is not limited and may be 0.1 μm, for example.

The amount of the aluminum tripolyphosphate added to the iron-based soft magnetic powder is preferably 0.10 mass % or more. The amount added is more preferably 0.15 mass % or more. Further, the amount added is preferably 0.50 mass % or less. The amount added is more preferably 0.30 mass % or less.

The method of forming the first coating layer on the surface of the iron-based soft magnetic particles is described below. For example, the first coating layer is formed on the particle surface of the iron-based soft magnetic particles by adding tripolyphosphate aluminum to the iron-based soft magnetic powder and mixing to obtain a powder consisting of coated particles with only the first coating layer formed. The amount of aluminum tripolyphosphate added may be as described above. Forming the first coating layer can be carried out by a dry method without using water or an organic solvent. Therefore, forming the first coating layer does not require a solvent drying operation and can be easily carried out.

Mixing to form the first coating layer may be carried out using a mixing device normally used for stirring and mixing powders. An example of a suitable mixing device is a stirring vane type mixer with stirring vanes rotating along a horizontal plane at the bottom of a mixing vessel. Examples of suitable stirring vane type mixers are the FM Mixer series produced by Nippon Coke & Engineering Co., Ltd., and the High Speed Mixer series produced by Earth Technica Co., Ltd.

In order to improve the adhesion between the aluminum tripolyphosphate and the iron-based soft magnetic particles, the mixing is preferably heated mixing. Maximum arrival temperature of the temperature of the powder during stirring and mixing to form the first coating layer is preferably 130° C. or more. The maximum arrival temperature is more preferably 150° C. or more. By setting the maximum arrival temperature of the mixing temperature to 130° C. or more, the adhesion between the first coating layer and the iron-based soft magnetic particles is improved. The higher the temperature of the powder, the more easily the aluminum tripolyphosphate forms the first coating layer. On the other hand, when the mixing temperature exceeds 200° C., oxidation of the iron-based soft magnetic composite powder progresses and the density of a dust core decreases. The maximum arrival temperature is therefore preferably 200° C. or less. The temperature of the powder during stirring and mixing is, for example, the temperature measured by a thermocouple inserted into the tank of the mixing vessel of the mixing device. When using a thermocouple to measure the temperature of the powder during stirring and mixing, the thermocouple is installed in a position buried in a powder layer (layer of powder) that is stationary in the tank of the mixing vessel when the mixing device is stationary.

After the formation of the first coating layer, the powder consisting of coated particles with only the first coating layer formed is preferably cooled. The cooling is preferably carried out to a temperature of 80° C. or less. This makes the subsequent iron-based soft magnetic composite powder easier to handle. In the following, the process of cooling the powder consisting of coated particles after the formation of the first coating layer is referred to as the cooling process. The cooling process is preferably carried out while the coated particles are being stirred and mixed.

The tank of the mixing vessel may be filled with an inert gas such as nitrogen gas. This prevents oxidation of the iron-based soft magnetic powder during stirring and mixing.

Next, the second coating layer according to an embodiment of the present disclosure is described. The second coating layer is a layer that together with the first coating layer constitutes the insulating layer. The second coating layer is formed on a layer of the first coating layer and is made of silicone resin.

Compared to aluminum tripolyphosphate, the silicone resin has poor wettability with the particle surface of the iron-based soft magnetic powder and inferior adhesiveness and adhesion to the iron-based soft magnetic powder, but has excellent heat resistance. As described later, the silicone resin has a characteristic of being able to coat the iron-based soft magnetic powder by utilizing the softening caused by heating, and therefore is suitable as a material for an insulating layer to be used together with aluminum tripolyphosphate.

The silicone resin is not limited, but is preferably one with a side chain consisting mainly of a methyl group. The silicone resin is preferably used in powder form, that is, silicone resin powder. Examples of suitable silicone resin powders are SILRES® MK POWDER (SILRES is a registered trademark in Japan, other countries, or both), produced by Wacker Asahikasei Silicone Co., Ltd., and KR-220LP, produced by Shin-Etsu Chemical Co., Ltd.

The amount of the silicone resin added is preferably 0.10 mass % or more relative to the iron-based soft magnetic powder. Below 0.10 mass %, the effect of improving the flexibility of the insulating layer by adding silicone resin may become less apparent. Further, the amount added is preferably 1.50 mass % or less relative to the iron-based soft magnetic powder. By adjusting the amount of the silicone resin added, physical properties (for example, specific resistance) pertaining to the insulating properties of the iron-based soft magnetic composite powder can be controlled. As specific examples, the amount added can be relatively small, such as 0.50 mass % or less, and particularly 0.30 mass % or less. In such a case, the specific resistance of the iron-based soft magnetic composite powder may be adjustable to an appropriate value (as an example, the specific resistance is from 100 μm to 2000 μΩm) to provide the iron-based soft magnetic composite powder that is particularly suitable for a magnetic core of a motor. The amount of silicone resin added can be relatively large, such as more than 0.50 mass %. In such a case, the specific resistance of the iron-based soft magnetic composite powder may be adjustable to a value greater than that suitable for a magnetic core of a motor (as an example, the specific resistance exceeds 2000 μΩm) to provide the iron-based soft magnetic composite powder that is particularly suitable for a magnetic core of a reactor or inverter.

The total amount of coating material added to form the insulating layer, that is, the aluminum tripolyphosphate and the silicone resin, relative to the iron-based soft magnetic powder, is preferably 2.00 mass % or less. The total amount is more preferably 0.60 mass % or less. The total amount is even more preferably 0.50 mass % or less. A lower limit of the total amount added is not particularly limited. The total amount added is preferably 0.20 mass % or more, relative to the iron-based soft magnetic powder.

As mentioned above, the silicone resin has poor wettability with the iron-based soft magnetic particle surface. Therefore, the coverage tends to be low when attempting to form a coating layer using only softened silicone resin. In contrast, aluminum tripolyphosphate has good adhesion to the surface of the iron-based soft magnetic particles, as described above, and can easily form an insulating layer on the particle surface when mixed with the iron-based soft magnetic powder. However, to achieve high coverage, a large amount of the aluminum tripolyphosphate needs to be added. Therefore, when these coating materials for insulation are used alone, high coverage is difficult to achieve, or even when high coverage is achieved, the material is added in a large quantity and suitable performance as a dust core is not obtainable. However, by forming the insulating layer as a composite coating including the silicone resin and the aluminum tripolyphosphate, the formation of the insulating layer having a high coverage (85% or more) can be achieved even when a small amount of coating material is added. The high coverage is achieved by forming the aluminum tripolyphosphate layer on the particle surface, which greatly improves the wettability of the softened silicone resin to the particle surface. The method of forming the second coating layer on the particle surface of powder consisting of coated particles with only the first coating layer formed is described below. For example, the second coating layer formed by the silicone resin can be formed on the first coating layer by adding and mixing silicone resin powder to powder consisting of coated particles with only the first coating layer formed. The amount of the silicone resin added may be as described above. The insulating layer including the second coating layer made of silicone resin improves the flexibility of the insulation layer and suppresses breakage of the insulation layer during compression molding.

Forming the second coating layer can be carried out by a dry method without use of water or an organic solvent. Forming the second coating layer therefore does not require a solvent drying operation and can be easily carried out.

Mixing to form the second coating layer may be carried out using a mixing device normally used for stirring and mixing powders. An example of a suitable mixing device is the same as that used to form the first coating layer.

The temperature of the powder during stirring and mixing to form the second coating layer is preferably 100° C. or more. When the temperature of the powder during the stirring and mixing is below 100° C., the silicone resin may not soften sufficiently, resulting in reduced adhesion of the second coating layer and decreased coverage. An upper limit of the temperature is not particularly limited. The temperature is preferably 200° C. or less.

Mixing to form the second coating layer is preferably carried out during the cooling process after the heating and mixing to form the first coating layer. That is, during the cooling process described above, the powder consisting of coated particles with only the first coating layer formed is preferably stirred and mixed, and silicone resin powder is preferably added to the powder. This makes it possible to utilize the heat stored in the powder layer of the coated particles immediately after the formation of the first coating layer to efficiently form the second coating layer with good adhesion while keeping production costs down. In detail, when compared to a case where the powder is cooled sufficiently after the formation of the first coating layer and then heated again to form the second coating layer, the temperature of the powder required to form the second coating layer can be secured while eliminating the time and effort of heating again.

In summary, a suitable method of producing the iron-based soft magnetic composite powder according to an embodiment of the present disclosure is to add the aluminum tripolyphosphate to the iron-based soft magnetic powder and mix, and then add the silicone resin powder and mix. By adding the aluminum tripolyphosphate to the iron-based soft magnetic powder and mixing, a powder consisting of coated particles with only the first coating layer formed can be produced. Further, by adding the silicone resin powder to the powder and mixing, the iron-based soft magnetic composite powder including the coated particles that have the insulating layer formed can be produced, the insulating layer comprising the first coating layer and the second coating layer. Here, the iron-based soft magnetic composite powder may be the iron-based soft magnetic composite powder consisting of the coated particles that have the insulating layer formed, the insulating layer comprising the first coating layer and the second coating layer.

That is, the production method is a method of adding the aluminum tripolyphosphate to the iron-based soft magnetic powder and mixing to obtain a powder consisting of coated particles with only the first coating layer formed, and then adding the silicone resin powder to the powder and mixing to obtain the iron-based soft magnetic composite powder including coated particles that have the insulating layer formed, the insulating layer comprising the first coating layer and the second coating layer.

The production method may be a method of adding the aluminum tripolyphosphate to the iron-based soft magnetic powder and mixing to obtain a powder consisting of coated particles with only the first coating layer formed, and then adding the silicone resin powder to the powder and mixing to obtain the iron-based soft magnetic composite powder consisting of coated particles that have the insulating layer formed, the insulating layer comprising the first coating layer and the second coating layer.

Similarly, a suitable method of producing the iron-based soft magnetic composite powder is adding the silicone resin powder to powder consisting of coated particles with only the first coating layer formed and mixing to obtain the iron-based soft magnetic composite powder including coated particles that have the insulating layer formed, the insulating layer comprising the first coating layer and the second coating layer.

The production method may be a method of adding the silicone resin powder to powder consisting of coated particles with only the first coating layer formed and mixing to obtain the iron-based soft magnetic composite powder consisting of coated particles that have the insulating layer formed, the insulating layer comprising the first coating layer and the second coating layer.

In this way, the iron-based soft magnetic composite powder including coated particles that have the insulating layer formed on the particle surface of the iron-based soft magnetic particles can be produced.

The following describes the coverage of the insulating layer on the particle surface of the iron-based soft magnetic particles (hereinafter also simply referred to as coverage).

The coverage is 85% or more. The coverage is preferably 90% or more. When the coverage is less than 85%, regions lacking the insulating layer on the coated particle surfaces come into contact with each other, and the insulating property of a dust core are significantly decreased. Further, a region where the insulating layer on the coated particle surface is missing can easily become an initiation point for breakdown of a dust core, and from the viewpoint of maintaining mechanical strength, the coverage is 85% or more. An upper limit of the coverage is not particularly limited and may be 100%.

According to an embodiment of the present disclosure, the coverage is preferably a value calculated by Expression 1 [(1-β/a)×100]. Here, a is the energy spectrum area attributed to Fe as measured by low-energy ion scattering spectroscopy with respect to the iron-based soft magnetic particles, and β is the energy spectrum area attributed to Fe as measured by low-energy ion scattering spectroscopy with respect to the coated particles. In measuring a, iron-based soft magnetic powder can be used as the iron-based soft magnetic particles. The iron-based soft magnetic powder may be either the iron-based soft magnetic powder used as raw material for the iron-based soft magnetic composite powder or powder from which the insulating layer has been removed from the iron-based soft magnetic composite powder. In measuring B, the iron-based soft magnetic composite powder can be used as the coated particles. That is, the coverage can be calculated by measuring the energy spectrum area attributed to Fe for the powder before and after the insulating layer is formed, and using the area ratio β/a.

Low-energy ion scattering spectroscopy has extremely high surface sensitivity and is affected by the atoms of the outermost surface layer, making it possible to accurately analyze the presence or absence of coating. That is, Expression 1 can be used to accurately determine coverage.

The coverage calculated from Expression 1 is preferably 85% or more. The coverage is more preferably 90% or more. An upper limit of the coverage is not particularly limited and may be 100%.

Next, lubricant is described. The iron-based soft magnetic composite powder does not need to include a lubricant and may have a lubricant content of 0 mass %. However, the iron-based soft magnetic composite powder according to an embodiment of the present disclosure preferably includes a lubricant. This decreases friction between the iron-based soft magnetic composite particles and suppresses breakdown of the insulating layer during compression molding. Particularly when compression molding is carried out at high pressure, when a lubricant is added to the iron-based soft magnetic composite powder in advance, the effect of suppressing breakdown of the insulating layer during compression molding may be enhanced. From this perspective, the lubricant content is preferably 0.20 mass % or more. However, mixing an excessive amount of lubricant may result in decreased flowability. The iron-based soft magnetic composite powder therefore preferably includes 0.60 mass % or less of lubricant. The lubricant content is expressed as the ratio of the mass of the lubricant to the mass of the entirety of the iron-based soft magnetic composite powder excluding the lubricant.

An upper limit of the ratio of the coated particles to the iron-based soft magnetic composite powder is not particularly limited and may be 100 mass %.

From the viewpoint of decreasing friction due to the inclusion of lubricant, the ratio is preferably 99.80 mass % or less. Further, a lower limit of the ratio is not particularly limited. The ratio is preferably 90.00 mass % or more. From the viewpoint of improving flowability, the ratio is more preferably 99.40 mass % or more.

For example, an organic lubricant may be used as the lubricant. Examples of organic lubricants include waxes and metal soaps. Examples of waxes include stearamide, erucamide, N,N′-ethylene bis-stearamide, and the like. Examples of metal soaps include lithium stearate, zinc stearate, and the like. Further, a mixture of a plurality of organic lubricants can be used as the organic lubricant, or a molten mixture of a plurality of organic lubricants can be used as the organic lubricant. The form of the lubricant is not particularly limited. A powder may be used.

In the method of producing an iron-based soft magnetic composite powder according to an embodiment of the present disclosure, it is preferable to mix an organic lubricant powder with the powder that includes the coated particles. In other words, a suitable method of producing an iron-based soft magnetic composite powder according to an embodiment of the present disclosure is a method of mixing an organic lubricant powder with a powder including the coated particles that have the first coating layer and the second coating layer formed.

Next, compression molding of the iron-based soft magnetic composite powder is described. The iron-based soft magnetic composite powder is filled into the press mold and then compression molded (pressed) to desired dimensions to form a formed body (compacted powder) of a defined shape. As a compression molding method for producing a formed body by compression molding the iron-based soft magnetic composite powder, an ordinary molding method such as room temperature molding or press mold lubrication molding may be used, for example.

In the compression molding of the iron-based soft magnetic composite powder, a lower limit of molding pressure is not particularly limited and may be any molding pressure as long as the necessary strength is imparted to the formed body. However, the molding pressure is preferably 980 MPa or more. Increased molding pressure increases compressed density, which may increase the strength of the formed body.

During compression molding of the iron-based soft magnetic composite powder, lubricant may be applied to the press mold walls as required, and lubricant may be added to the iron-based soft magnetic composite powder in advance as described above. The application or addition of a lubricant can improve formability in compression molding. That is, friction between the press mold and the iron-based soft magnetic composite powder can be decreased during compression molding. Further, a decrease in density of the formed body during compression molding can be suppressed. Further, friction can be decreased when removing the formed body from the press mold after compression molding. Further, cracking of the formed body during molding and when the formed body is extracted from the press mold can be suppressed.

### EXAMPLES

The following describes the method of producing an iron-based soft magnetic composite powder and the iron-based soft magnetic composite powder according to the present disclosure, based on Examples. The present embodiment is not limited to the Examples described.

### Example 1

Example 1 is described below.

Water-atomized iron powder (JIP 304AS, produced by JFE Steel Corporation) having an apparent density of 3.0 Mg/m³ and a median size of 100 μm was used as the iron-based soft magnetic powder. Aluminum tripolyphosphate powder having a median size of approximately 5 μm (K-FRESH #100P, produced by Tayca Co., Ltd., aluminum dihydrogen tripolyphosphate dihydrate powder) was used at the aluminum tripolyphosphate. Silicone resin powder (KR-220LP, produced by Shin-Etsu Chemical Co., Ltd.) was used as the silicone resin. The mixing device used was a High Speed Mixer model LFS-GS2J, produced by EarthTechnica Co., Ltd.

First, the iron-based soft magnetic powder and the aluminum tripolyphosphate powder as raw material powder were stirred and mixed to obtain a powder of coated particles with the first coating layer formed. Details are as follows. As listed in Table 1, the amount of the aluminum tripolyphosphate powder added was 0.2 mass %. The stirring and mixing of the raw material powder was carried out using the mixing device with the stirring vanes rotating at 500 rpm (revolutions/min). The raw material powder was then stirred and mixed for 20 min to obtain the powder of coated particles with the first coating layer formed. The amount of raw material powder fed into the mixing device was 1.5 kg. The amount of the aluminum tripolyphosphate indicated in Table 1 is a percentage relative to the mass of the iron-based soft magnetic powder. Stirring and mixing were carried out while the mixing vessel was heated. Maximum arrival temperature of the temperature of the powder during stirring and mixing was controlled to be 170° C. During mixing, nitrogen gas was supplied to the tank of the mixing vessel and the inside of the mixing vessel was filled with nitrogen gas.

TABLE 1

| | | | Iron-based soft magnetic | | | | |
|---|---|---|---|---|---|---|---|
| | Coating material | | powder coating state | | Lubricant | | |
| | Aluminum | Silicone | Fe peak | Coverage | | Added | |
| | tripolyphosphate | resin | area ratio | (1 − β/α) × | | amount | Flow rate |
| | (mass %) | (mass %) | β/α | 100 (%) | Component | (mass %) | (s/50 g) |
| Comparative Example 1 | 0.0 | 0.0 | 1.00 | 0.0 | EBS | 0.40 | No flow |
| Comparative Example 2 | 0.4 | 0.0 | 0.23 | 77.0 | EBS | | No flow |
| Comparative Example 3 | 0.0 | 0.4 | 0.19 | 81.0 | EBS | | No flow |
| Example 1 | 0.2 | 0.2 | 0.08 | 92.0 | EBS | | 22.7 |
| Example 2 | | | | | Mixed lubricant | | 22.6 |
| Example 3 | | | | | Stearamide | | 23.1 |
| Example 4 | | | | | Erucamide | | 23.2 |
| Example 5 | | | | | Lithium stearate | | 22.6 |
| Example 6 | | | | | Zinc stearate | | 22.9 |
| Example 7 | | 2.0 | 0.01 | 99.2 | EBS | | 23.7 |
| Comparative Example 4 | 0.1 | 0.1 | 0.17 | 83.0 | EBS | 0.40 | No flow |
| Example 8 | 0.2 | 0.2 | 0.08 | 92.0 | — | — | 18.5 |
| Example 9 | | | | | EBS | 0.20 | 21.9 |
| Example 10 | | | | | EBS | 0.60 | 26.2 |
| Example 11 | | | | | EBS | 0.70 | 32.4 |
| Example 12 | | | | | Mixed lubricant | 0.20 | 22.1 |
| Example 13 | | | | | Mixed lubricant | 0.60 | 26.9 |
| Example 14 | | | | | Mixed lubricant | 0.70 | 33.2 |

Further, silicone resin powder was added to the powder in the tank of the mixing vessel in an amount indicated in Table 1 (0.2 mass %) and stirred and mixed to obtain a powder of coated particles with the second coating layer formed. The amount of silicone resin powder indicated in Table 1 is a percentage relative to the mass of the iron-based soft magnetic powder. The silicone resin powder was added and stirred during the cooling process after the 20 min of stirring and mixing described above (the rotation speed of the stirring vanes was 500 rpm). The silicone resin powder was added to the powder in the tank when the temperature of the powder in the mixing device dropped to 150° C. After the silicone resin powder was added, mixing was continued until the temperature of the powder in the mixing device cooled to 60° C. to obtain a powder including coated particles having the first coating layer and the second coating layer (the iron-based soft magnetic composite powder for a dust core).

After the temperature of the powder in the mixing device was cooled to 60° C., organic lubricant according to the component and addition amount indicated in Table 1 was added to the powder in the tank of the mixing vessel, and further stirred and mixed for 5 min with the rotation speed of the stirring blade at 500 rpm, after which the powder was removed from the tank of the mixing vessel to obtain the iron-based soft magnetic composite powder for Example 1. EBS in Table 1 refers to N,N′-ethylene bis-stearamide. Further, “Mixed lubricant” refers to an organic lubricant made by melting and mixing 50 mass % stearamide and 50 mass % N,N′-ethylene bis-stearamide.

The iron-based soft magnetic composite powder of Example 1 and the iron-based soft magnetic powder used as the raw material for the iron-based soft magnetic composite powder (corresponding to the iron-based soft magnetic composite powder from which the insulating layer was removed) were subjected to surface analysis by low-energy ion scattering, and the peak area ratio (β/α) and coverage [(1−β/α)×100] were calculated. A low-energy ion scattering spectrometer (Qtac¹⁰⁰) produced by IONTOF GmbH was used for the measurements, with 5 keV 20Ne⁺ as the incident ion, and the energy spectrum attributed to Fe was used to calculate the coverage. The results of these measurements are listed together in Table 1.

The flowability of the iron-based soft magnetic composite powder according to Example 1 was measured based on the JIS Z 2502:2020 measurement for flow rate (s/50 g). The results of this measurement are also listed in Table 1.

### Examples 2 to 14

The iron-based soft magnetic composite powders for Examples 2 to 14 were produced under the same conditions as in Example 1, except that the type or amount of organic lubricant added was different from that used for Example 1. The type and amount of organic lubricant added to the iron-based soft magnetic composite powders for Examples 2 to 14 are listed in Table 1. The flow rate, peak area ratio, and coverage of the iron-based soft magnetic composite powders for Examples 2 to 14 are also listed in Table 1.

Examples 2 to 6 differed from Example 1 only in the type of organic lubricant.

In Example 7, the amount of silicone resin added differed from that in Example 1, and the other conditions were the same as in Example 1.

Example 8 differed from Example 1 in that no organic lubricant was added, and the other conditions were the same as in Example 1.

In Examples 9 to 11, the amount of organic lubricant added differed from that in Example 1, and the other conditions were the same as in Example 1.

In Examples 12 to 14, the type of organic lubricant was the same as in Example 2, and the amount of organic lubricant added differed from that in Example 1.

### Comparative Example 1

The mixed iron-based soft magnetic powder for Comparative Example 1 differed from Example 1 in that none of the coating materials were added, and the powder was otherwise produced under the same conditions as in Example 1. The flow rate, peak area ratio, and coverage of the mixed iron-based soft magnetic powder for Comparative Example 1 are also listed in Table 1.

### Comparative Examples 2, 3

The iron-based soft magnetic composite powders for Comparative Examples 2 and 3 differed from Example 1 in that one of aluminum tripolyphosphate or silicone resin was not added, and were otherwise produced under the same conditions as in Example 1. In Comparative Examples 2 and 3, the total amount of coating material added was the same as in Example 1. The types and amounts of coating material and organic lubricant added to the iron-based soft magnetic composite powders for Comparative Examples 2 and 3 are listed in Table 1. The flow rate, peak area ratio, and coverage of the iron-based soft magnetic composite powders for Comparative Examples 2 and 3 are also listed in Table 1.

### Comparative Example 4

The iron-based soft magnetic composite powder for Comparative Example 4 differed from Example 1 in that the amount of coating material added was small, and was otherwise produced under the same conditions as in Example 1. The amount of coating material added to the iron-based soft magnetic composite powder for Comparative Example 4 is indicated in Table 1. The flow rate, peak area ratio, and coverage of the iron-based soft magnetic composite powder for Comparative Example 4 are also listed in Table 1.

In the coverage column of Table 1, the coverage values (numerical values) are underlined when the coverage value is below 85%.

As indicated in Table 1, the mixed powder of the iron-based soft magnetic powder (see Comparative Example 1) and the iron-based soft magnetic composite powder (see Comparative Examples 2 to 4) for the Comparative Examples had such poor flowability (no flow) that evaluation of flowability could not be performed. In contrast, the flowability of the iron-based soft magnetic composite powder of the Examples was improved to the extent that flowability could be evaluated. In particular, the iron-based soft magnetic composite powders of the Examples other than Examples 11 and 14 were extremely good, achieving a flowability of 27 s/50 g or less while having an insulating layer.

Further, in the iron-based soft magnetic composite powders of the Examples, the flowability of the Example without organic lubricant mixed in (see Example 8) did not decrease drastically compared to those with organic lubricant mixed in (see Examples 1 to 7 and 9 to 14). Therefore, all of the iron-based soft magnetic composite powders of the Examples would not clog in the storage container of the iron-based soft magnetic composite powder, and had enough flowability to ensure that uniform filling is not inhibited when the iron-based soft magnetic composite powder is filled into a press mold.

However, when 0.70 mass % of organic lubricant was added (see Examples 11 and 14), there was a decrease in flowability compared to the other Examples, even when the coverage of the coating material was 85% or more, for example, greater than 90%. However, even in this case, the powder achieved higher flowability than the powder of the Comparative Examples. Comparisons of Examples 1, and 8 to 12, as well as Examples 2, 8, and 12 to 14, indicate that flowability improves further as the amount of organic lubricant added decreases.

Accordingly, it is possible to provide an iron-based soft magnetic composite powder for a dust core that has an insulating layer and also high flowability, and a method of easily producing same.

The embodiments disclosed herein are merely examples, and variations as appropriate within the scope of the present disclosure may be made without being limited to the disclosed embodiments.

### INDUSTRIAL APPLICABILITY

The present disclosure is applicable to iron-based soft magnetic composite powders for dust cores and methods of producing same.

1. An iron-based soft magnetic composite powder for a dust core, the iron-based soft magnetic composite powder comprising coated particles having an insulating layer formed on the particle surface of iron-based soft magnetic particles,
the insulating layer comprising:
a first coating layer formed of aluminum tripolyphosphate disposed on the particle surface; and
a second coating layer formed of silicone resin disposed on the first coating layer, wherein
coverage of the insulating layer on the particle surface is 85% or more.

2. The iron-based soft magnetic composite powder for a dust core according to claim 1, wherein the coverage is a value calculated by the following Expression,
where α is the energy spectrum area attributed to Fe as measured by low-energy ion scattering spectroscopy with respect to the iron-based soft magnetic particles, and
β is the energy spectrum area attributed to Fe as measured by low-energy ion scattering spectroscopy with respect to the coated particles,
$$( 1 - β / α ) \times 100. \qquad ( Expression 1 )$$

3. The iron-based soft magnetic composite powder for a dust core according to claim 1, further comprising an organic lubricant in an amount from 0.20 mass % to 0.60 mass %.

4. The iron-based soft magnetic composite powder for a dust core according to claim 2, further comprising an organic lubricant in an amount from 0.20 mass % to 0.60 mass %.

5. A method of producing the iron-based soft magnetic composite powder for a dust core according to claim 1, the method comprising
adding and mixing a silicone resin powder to powder consisting of coated particles with only the first coating layer formed, thereby forming the second coating layer.

6. The method of producing an iron-based soft magnetic composite powder for a dust core according to claim 5, wherein the powder containing the coated particles is mixed with an organic lubricant powder.

7. A method of producing the iron-based soft magnetic composite powder for a dust core according to claim 2, the method comprising
adding and mixing a silicone resin powder to powder consisting of coated particles with only the first coating layer formed, thereby forming the second coating layer.

8. A method of producing the iron-based soft magnetic composite powder for a dust core according to claim 3, the method comprising
adding and mixing a silicone resin powder to powder consisting of coated particles with only the first coating layer formed, thereby forming the second coating layer.

9. A method of producing the iron-based soft magnetic composite powder for a dust core according to claim 4, the method comprising
adding and mixing a silicone resin powder to powder consisting of coated particles with only the first coating layer formed, thereby forming the second coating layer.

10. The method of producing an iron-based soft magnetic composite powder for a dust core according to claim 7, wherein the powder containing the coated particles is mixed with an organic lubricant powder.

11. The method of producing an iron-based soft magnetic composite powder for a dust core according to claim 8, wherein the powder containing the coated particles is mixed with an organic lubricant powder.

12. The method of producing an iron-based soft magnetic composite powder for a dust core according to claim 9, wherein the powder containing the coated particles is mixed with an organic lubricant powder.
